(19) United States
(12) Patent Application Publication
(10) Pub. No.: US 2026/0285545 A1
(43) Pub. Date: Sep. 24, 2026

(54) RESEALABLE BAG ENCLOSURE WITH SCALLOPED TABS

(71) Applicant: Illinois Tool Works Inc., Glenview, IL (US)

(72) Inventor: David J. Matthews, Gilman, IL (US)

(73) Assignee: Illinois Tool Works Inc., Glenview, IL (US)

(21) Appl. No.: 19/407,826

(22) Filed: Dec. 3, 2025

Related U.S. Application Data
(60) Provisional application No. 63/739,274, filed on Dec. 27, 2024.

(51) Int. Cl. B65D 33/00; B31B 70/81; B31B 160/10; B65D 33/25

(52) U.S. Cl. CPC B65D 33/007; B31B 70/8131; B65D 33/2508; B31B 2160/10

(57) ABSTRACT

A resealable bag enclosure includes a body portion configured to hold a product and a zipper attached to the body portion. The zipper comprises a first zipper half and a second zipper half, each with interlocking profiles that repeatedly mate and separate to seal and open the bag enclosure. A tab extends from the first or second zipper half, featuring a scalloped shape. The scalloped shape reduces the risk of snagging during sealing in an auto bag opening machine or decreases the force required to open the zipper by ensuring only one interlocking profile opens at a time. The scalloped shape includes curved indentations on opposite lateral edges of the tab, smoothly transitioning to a linear edge. The tab may be one of multiple tabs forming a curved waveform with the consumer-facing edge of the zipper.

### CROSS-REFERENCE TO RELATED APPLICATIONS

This application claims priority to U.S. Provisional Application No. 63/739,274 (filed 27 Dec. 2024), the entire disclosure of which is incorporated herein by reference.

### BACKGROUND

### Technical Field

The subject matter described herein relates to packaging technology, specifically to resealable bags having zippers that are pulled apart to open the bags and pressed together to seal the bags closed.

### Discussion of Art

The packaging industry frequently encounters challenges with resealable bags, especially child-resistant enclosures, during the process of filling the bags with product. Current methods involve cutting access points to facilitate consumer access. However, these access points often present issues during the packaging process. Specifically, a bag converter can experience difficulties when attempting to automatically open the enclosure for filling. The opening devices can include plow bodies that are intended to slide between flanges of the zippers to pull the zippers open.

But these plow bodies can catch or snag on the access points, rendering the enclosure nonfunctional. This problem is exacerbated by blunt 90-degree angles of the access points (e.g., tabs), which increase the likelihood of snagging. The design of these tabs can lead to tearing or breaking of the enclosure, especially in multi-piece configurations. This issue necessitates a solution that addresses the access point design to ensure smooth operation during the packaging process, thereby maintaining the functionality of the enclosures.

### BRIEF SUMMARY

In one example, a resealable bag enclosure comprises a body portion configured to hold a product; a zipper attached to the body portion, the zipper comprising a first zipper half and a second zipper half, the first zipper half including a first interlocking profile, the second zipper half including a second interlocking profile, the first interlocking profile and the second interlocking profile configured to repeatedly mate and separate from each other to repeatedly seal and open, respectively, the bag enclosure; and a tab extending from the first zipper half or the second zipper half, the tab having a scalloped shape.

According to another example, a method for forming a resealable bag enclosure comprises forming a body portion configured to hold a product; forming a zipper comprising a first zipper half and a second zipper half, the first zipper half including a first interlocking profile, the second zipper half including a second interlocking profile, the first interlocking profile and the second interlocking profile configured to repeatedly mate and separate from each other to repeatedly seal and open, respectively, the bag enclosure; cutting the first zipper half to form a tab extending from the first zipper half or the second zipper half, the tab cut to have a scalloped shape; and attaching the zipper to the body portion.

### BRIEF DESCRIPTION OF THE DRAWINGS

The inventive subject matter may be understood from reading the following description of non-limiting embodiments, with reference to the attached drawings, wherein below:

FIG. 1 illustrates a front view of one example of a resealable bag enclosure with scalloped tabs;

FIG. 2 illustrates a comparison of the scalloped tabs of the bag enclosure shown in FIG. 1 with orthogonal tabs of other bag enclosures;

FIG. 3 illustrates one of the scalloped tabs shown in FIG. 1; and

FIG. 4 illustrates a flowchart of one example of a method for creating a resealable bag enclosure with scalloped tabs.

### DETAILED DESCRIPTION

The packaging industry frequently encounters challenges with resealable bag enclosures, particularly those designed for child-resistant zippers. These zippers can be designed to prevent children from easily accessing the contents while remaining user-friendly for adults. The process of opening and resealing these bags often involves tabs that facilitate the separation of the zipper halves. However, the current designs of these tabs can lead to significant issues during the packaging process. Some existing resealable bag enclosures with child-resistant zippers often feature tabs with blunt edges. These blunt edges can snag on the machinery used to open the zippers for product filling, causing the tabs to tear or the zipper to malfunction. This snagging issue not only disrupts the packaging process but also compromises the integrity of the bag, leading to potential product loss and increased production costs. Additionally, the force required to open these zippers can be substantial, making them difficult for consumers to use effectively. The subject matter described herein addresses these issues by introducing a resealable bag enclosure with a scalloped tab. This tab has a scalloped shape that reduces the risk of snagging during the packaging process and decreases the force required to open the zipper. The scalloped design can protrude from one zipper half to ensure that one interlocking profile of the zipper is opened at a time, increasing the ease of use for consumers. This innovative approach not only improves the functionality of the resealable bag enclosure but also enhances the efficiency of the packaging process.

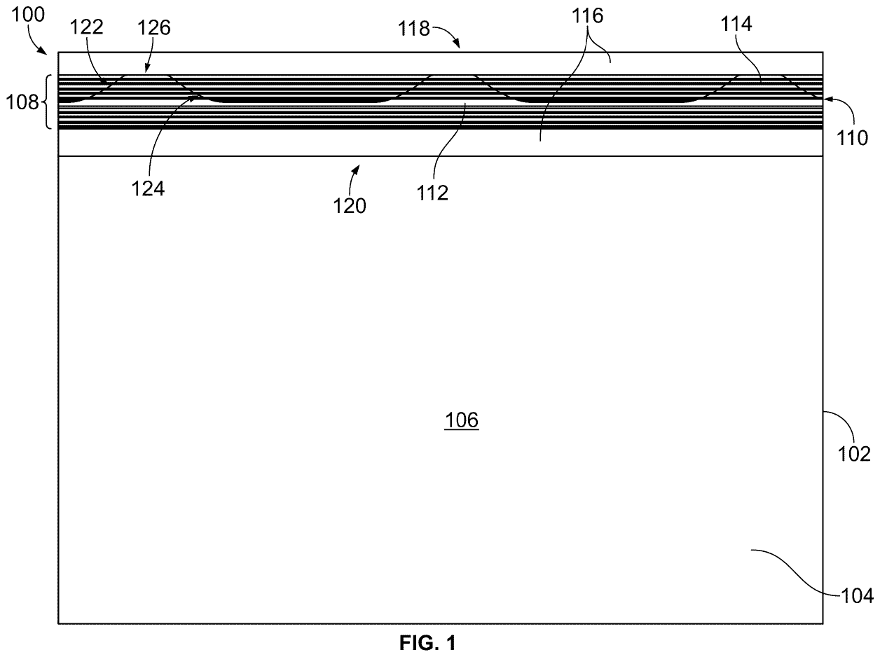

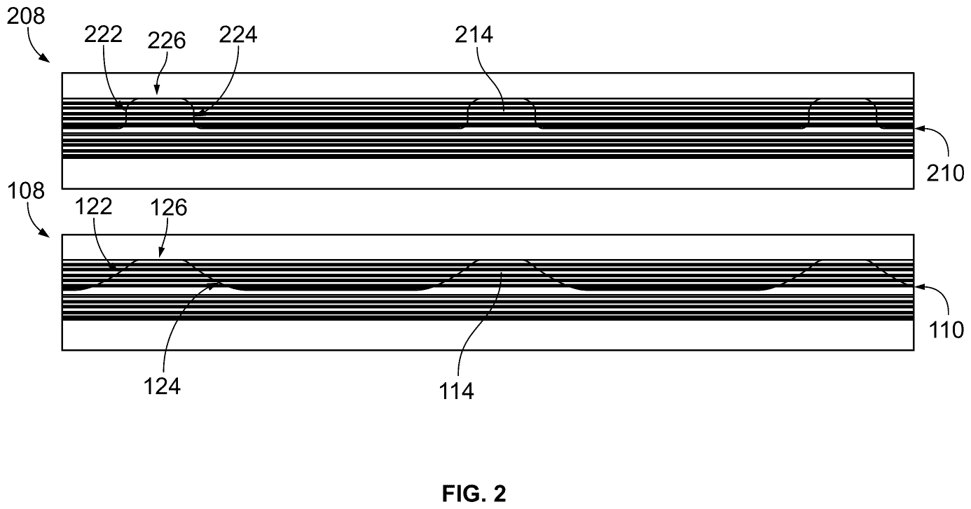

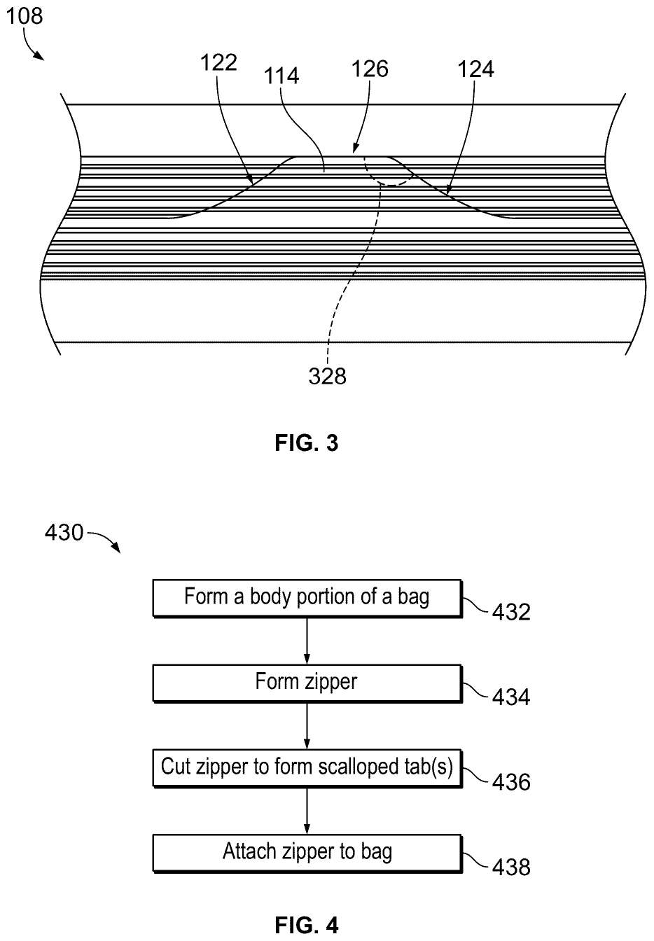

FIG. 1 illustrates a front view of one example of a resealable bag enclosure 100 with scalloped tabs 114. FIG. 2 illustrates a comparison of the scalloped tabs 114 of the bag enclosure 100 with orthogonal tabs 214 of other bag enclosures. FIG. 3 illustrates one of the scalloped tabs shown in FIG. 1. The resealable bag enclosure 100 includes a body portion 102 configured to hold a product. The body portion 102 forms the main structure of the bag 100 and is designed to contain various types of products so that the contents remain secure and protected. The body portion 102 can be fabricated from different materials, such as plastic films, laminates, or other flexible packaging materials. One or more films 104 form the material from which the body portion 102 is made. The film(s) 104 can be a single layer or a multi-layer structure that provides the necessary barrier properties to protect the product from environmental factors such as moisture, oxygen, and light.

The body portion 102 can be formed from a single film 104 that is folded and sealed along one or more edges, or multiple films 104 sealed together to form an open mouthed bag 100. The body portion 102 includes an interior volume 106 that forms the space within the bag 100 where the product is stored. The interior volume 106 secures the product within the bag 100 to prevent spillage or contamination.

A zipper 108 is attached to the body portion 102 at or near an open mouth of the bag 100. The zipper 108 includes a first zipper half 110 and a second zipper half. The first zipper half 110 can extend along one side (e.g., the front) of the bag 100 while the second zipper half extends along the other side (e.g., the bag) of the bag 100. The zipper 108 is a resealable closure mechanism that allows the bag 100 to be repeatedly sealed and opened. The zipper halves 110 can each include an interlocking profile 112. The interlocking profiles 112 engage each other to secure the bag 100 in a closed or sealed state. The interlocking profiles 112 are designed to mate and separate repeatedly to ensure that the bag 100 can be opened and closed multiple times without losing the sealing capability. In one example, one interlocking profile 112 can be a protruding body with a bulbous head while the other interlocking profile 112 is a receptacle in which the head of the protruding body is received to seal the bag 100 shut. Alternatively, the interlocking profiles 112 may have other shapes.

The zipper halves 110 include flanges 116 that are coupled (e.g., heat sealed) with the body portion 102. The flange 116 provides a surface for attaching the zipper 108 to the body portion 102. The flange 116 extends from a consumer-side edge 118 that faces the consumer and a product-side edge 120 that faces the interior volume 106 of the body portion 102.

One or more tabs 114 extend from the zipper half 110. The tabs 114 are designed to facilitate the opening of the zipper 108 by the consumer. For example, the tabs 114 can be grasped by the consumer for the consumer to more easily pull one zipper half 110 (e.g., the zipper half 110 having the tabs 114) away from the other zipper half 110. The tabs 114 may protrude from only one zipper half 110 in one example. In another example, the tabs 114 may protrude from both zipper halves 110. While the illustrated example shows the front zipper half 110 having multiple (e.g., three) tabs 114, the zipper half 110 may have a single tab 114, two tabs 114, or more than four tabs 114 in other examples.

The tabs 114 may be formed by cutting through the zipper half 110 along a line that undulates to form the shape of the tabs 114. Pulling on the zipper half 110 may cause the tabs 114 to separate along this line (e.g., a cut line) so that pulling on the tab(s) 114 separates the tabs 114 along the cut line while also separating the interlocking profiles 112 of the zipper halves 108. The remaining portion of the zipper half 110 that does not separate with the tabs 114 (e.g., the portion above the cut line) may remain (e.g., coupled with the other zipper half). The tabs 114 may therefore interlock with this remaining portion. The interlocking portions of the tabs 114 can be referred to as tab interlocking portions while the interlocking portions of the zipper halves 108 may be referred to as zipper interlocking portions.

As shown in FIG. 2, some other bags can include zippers 208 with zipper halves 210 having interlocking profiles 112. These zippers 208 can include orthogonal tabs 214 for consumers to pull and open the zippers 208. These orthogonal tabs 214 have opposite lateral edges 222, 224 that are joined by a linear joining edge 226. As shown, the lateral edges 222, 224 extend or are oriented perpendicular to the length of the zipper 208 and zipper half 210, and the joining edge 226 extends or is oriented parallel to the length of the zipper 208 and zipper half 210.

During filling of the bags having the zippers 208 with orthogonal tabs 214, an automated opening machine can include bodies, or plows, which slide between the zipper halves 210 to open the zippers 208 and bags. The plows may be stationary while the bags 100 and zippers 208 move laterally relative to the plows (with the plows intended to slide between the zipper halves 210. But the orthogonal lateral edges 222, 224 that are perpendicular (or predominantly perpendicular) to the direction of movement of the plows (or of the zipper 208 relative to the plows) can catch or be caught on the plows. This can cause the plows to tear the tabs 214 and/or zippers 208. For example, the tab 214 may be torn from the zipper 208 and/or the zipper 208 may be torn from the film forming the bag.

In contrast to these orthogonal tabs 214, the tabs 114 according to the subject matter described herein have scalloped shapes. This shape can reduce the risk of snagging during an auto-opening the bag 100 and/or decrease the force required to open the zipper 108. The scalloped shape of the tab 114 includes curved indentations on opposite lateral edges 122, 124 of the tab 114. A joining edge 126 extends between and connects these lateral edges 122, 124 with each other. This joining edge 126 is shown as a linear edge oriented parallel to (or predominantly parallel to) the length of the zipper 108 and the direction in which the zipper 108 moves relative to the plow to open the zipper 108.

For example, each lateral edge 122, 124 may have a curved, concave shape that is not oriented perpendicular to the length of the zipper 108, to the length of the zipper half 110, or to the direction of travel of the zipper 108 relative to the plow during automated opening of the zipper 108. The edges 122, 124 are designed (e.g., shaped) with the curved indentations to create the scalloped shape, which helps prevent snagging. The joining edge 126 extends between the first lateral edge 122 and the second lateral edge 124, and has a continuous and smooth transition between the edges 122, 124 and the joining edge 126. An angle 328 between the joining edge 126 and each of the lateral edges 122, 124 may be larger than ninety degrees, at least one hundred thirty five degrees, or the like, to reduce the likelihood of the tabs 114 catching or snagging on the plows.

In contrast to the perpendicularly oriented lateral edges 222, 224 of the orthogonal tab 214 (which can be caught on the plows during opening of the zipper 208), the curved lateral edges 122, 124, the large angle 328 between the edges 126 and 122, 124, the small angle between the lateral edge 222 or 224 and the plow, and/or the smooth (non-orthogonal) transition between the edge 126 and the edges 122, 124 prevent the tab 114 from getting caught on the plow. As shown, the tabs 114 form a curved or undulating waveform shape along the zipper half 110. This curved or smooth shape causes the plow to move beneath the tab 114 without getting caught on and being pulled by the plow.

Additionally, providing the tabs 114 along one of the zipper halves 110 can make it easier for consumers to open the zipper 108. For example, a consumer may be able to place their thumb or fingers on the flange 116 of the back zipper half 110 while the other thumb or fingers pull on the tab 114 on the front zipper half 110. This can reduce the force needed to open the zipper 108 relative to the consumer not having the tabs 114 and being required to pull on both zipper halves 110.

FIG. 4 illustrates a flowchart of one example of a method 430 for creating a bag enclosure. The method 430 outlines the steps for forming the resealable bag enclosure 100 in one example. This method involves several steps, each contributing to the creation of a functional and efficient resealable bag.

At 432, a body portion of a bag is formed. The body portion can be configured to hold a product and can be made (e.g., extruded) from a flexible polymer-based or paper-based film. The body portion defines the interior volume where product is stored in the bag. The body portion can be formed using extrusion, molding, or lamination, depending on the material used.

At 434, a zipper is formed. The zipper is formed to include first and second zipper halves with each zipper half having an interlocking profile that allows the zipper halves to repeatedly mate and separate, thereby sealing and opening the bag enclosure. The zipper halves include flanges that are coupled with the body portion. The zipper can be formed using extrusion, for example.

At 436, the zipper is cut to form scalloped tab(s). The tab can extend from either the first zipper half or the second zipper half and have a scalloped shape. The scalloped shape includes curved indentations on opposite lateral edges, such as the first lateral edge 122 and the second lateral edge 124, with a joining edge 126 extending between and joining the lateral edges. The cutting process ensures that the scalloped shape is precise, reducing the risk of snagging during the sealing process and decreasing the force required to open the zipper 108. The cutting can be performed using high-precision cutting wheels or other suitable cutting tools to achieve the desired shape and functionality.

At 438, the zipper is attached to the bag. This can involve heat sealing, adhesive bonding, or ultrasonic welding of the zipper to the bag to seal the zipper to the body portion at or near the open mouth of the bag. The flange of the zipper can be sealed to the film(s) forming the bag portion.

In one example, a resealable bag enclosure comprises a body portion configured to hold a product; a zipper attached to the body portion, the zipper comprising a first zipper half and a second zipper half, the first zipper half including a first interlocking profile, the second zipper half including a second interlocking profile, the first interlocking profile and the second interlocking profile configured to repeatedly mate and separate from each other to repeatedly seal and open, respectively, the bag enclosure; and a tab extending from the first zipper half or the second zipper half, the tab having a scalloped shape.

The resealable bag enclosure can include the scalloped shape of the one or more tabs shaped to reduce a risk of snagging during opening of the first zipper half and the second zipper half in an auto bag opening machine and/or to decrease a force required to open the zipper by ensuring only the first interlocking profile or only the second interlocking profile is opened at a time.

The resealable bag enclosure can include the first zipper half with a first flange coupled with the body portion and from which the first interlocking profile projects, the second zipper half including a second flange coupled with the body portion and from which the second interlocking profile projects. Each of the first flange and the second flange can extend from a consumer-side edge that faces a consumer to a product-side edge that faces an interior volume of the body portion in which the product is held. The one or more tabs protrude above the consumer-side edge of the first flange or the second flange.

The resealable bag enclosure can include the scalloped shape of the tab including curved indentations on opposite lateral edges of the tab with a linear edge extending between and joining the lateral edges to each other. The resealable bag enclosure can include the curved indentations on the opposite lateral edges of the tab smoothly transitioning to the linear edge. The resealable bag enclosure can include the tab including opposite lateral edges and a joining edge that extends between and joins the lateral edges with each other, where the scalloped shape of the tab is devoid of an angle between the joining edge and either the lateral edges that is ninety degrees or less.

The resealable bag enclosure can include the tab including opposite lateral edges and a joining edge that extends between and joins the lateral edges with each other. The scalloped shape of the tab can be devoid of an angle between the joining edge and either of the lateral edges that is less than one hundred thirty-five degrees. The tab can be a first tab, and the bag also can include at least a second tab having the scalloped shape. The first tab, the at least the second tab, and a consumer-facing edge of the first zipper half or the second zipper half can form a curved waveform.

According to another example, a method for forming a resealable bag enclosure comprises forming a body portion configured to hold a product; forming a zipper comprising a first zipper half and a second zipper half, the first zipper half including a first interlocking profile, the second zipper half including a second interlocking profile, the first interlocking profile and the second interlocking profile configured to repeatedly mate and separate from each other to repeatedly seal and open, respectively, the bag enclosure; cutting the first zipper half to form a tab extending from the first zipper half or the second zipper half, the tab cut to have a scalloped shape; and attaching the zipper to the body portion.

The method can include the first zipper half cut to form the scalloped shape of the tab to reduce a risk of snagging during sealing of the first zipper half and the second zipper half in an auto bag opening machine. The method can include the first zipper half cut to form the scalloped shape of the tab to decrease a force required to open the zipper by ensuring only the first interlocking profile or only the second interlocking profile is opened at a time.

The method can include the first zipper half formed to include a first flange coupled with the body portion and from which the first interlocking profile projects, the second zipper half formed to include a second flange coupled with the body portion and from which the second interlocking profile projects, each of the first flange and the second flange extending from a consumer-side edge that faces a consumer and a product-side edge that faces an interior volume of the body portion in which the product is held, the first zipper half cut to form the tab so the tab protrudes above the consumer-side edge of the first flange or the second flange.

The method can include the first zipper half cut to have the scalloped shape of the tab that includes curved indentations on opposite lateral edges of the tab with a linear edge extending between and joining the lateral edges to each other. The method can include the first zipper half cut to form the curved indentations on the opposite lateral edges of the tab that smoothly transition to the linear edge.

The method can include the first zipper half cut to include, in the tab, opposite lateral edges and a joining edge that extends between and joins the lateral edges with each other, where the scalloped shape of the tab is cut to be devoid of an angle between the joining edge and either the lateral edges that is ninety degrees or less.

The method can include the first zipper half cut to include, in the tab, opposite lateral edges and a joining edge that extends between and joins the lateral edges with each other, where the scalloped shape of the tab is devoid of an angle between the joining edge and either of the lateral edges that is less than one hundred thirty-five degrees.

The method can include the first zipper half cut to form a first tab, and further comprising cutting the first zipper half to form at least a second tab having the scalloped shape, the first tab, the at least the second tab, and a consumer-facing edge of the first zipper half or the second zipper half forming a curved waveform.

According to another example, a resealable bag enclosure comprises a body portion configured to hold a product; a zipper attached to the body portion, the zipper comprising a first zipper half and a second zipper half, the first zipper half including a first interlocking profile, the second zipper half including a second interlocking profile, the first interlocking profile and the second interlocking profile configured to repeatedly mate and separate from each other to repeatedly seal and open, respectively, the bag enclosure; and a tab protruding above an upper edge of the first zipper half or the second zipper half, the tab having a scalloped shape that reduces a risk of snagging during sealing of the first zipper half and the second zipper half in an auto bag opening machine or decreases a force required to open the zipper by ensuring only the first interlocking profile or only the second interlocking profile is opened at a time, the scalloped shape of the tab including curved indentations on opposite lateral edges of the tab with a linear edge extending between and joining the lateral edges to each other, the curved indentations on the opposite lateral edges of the tab smoothly transitioning to the linear edge.

The resealable bag enclosure can include the tab being a first tab, and further comprising at least a second tab having the scalloped shape, the first tab, the at least the second tab, and a consumer-facing edge of the first zipper half or the second zipper half forming a curved waveform.

The singular forms “a,” “an,” and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A resealable bag enclosure comprising:
a body portion configured to hold a product;
a zipper attached to the body portion, the zipper comprising a first zipper half and a second zipper half, the first zipper half including a first interlocking profile, the second zipper half including a second interlocking profile, the first interlocking profile and the second interlocking profile configured to repeatedly mate and separate from each other to repeatedly seal and open, respectively, the bag enclosure; and
a tab extending from the first zipper half or the second zipper half, the tab having a scalloped shape.

2. The resealable bag enclosure of claim 1, wherein the scalloped shape of the one or more tabs is shaped to reduce a risk of snagging during filling of the body portion with the product.

3. The resealable bag enclosure of claim 1, wherein the scalloped shape of the one or more tabs is shaped to decrease a force required to open the zipper.

4. The resealable bag enclosure of claim 1, wherein the first zipper half includes a first flange coupled with the body portion and from which the first interlocking profile projects, the second zipper half includes a second flange coupled with the body portion and from which the second interlocking profile projects, each of the first flange and the second flange extending from a consumer-side edge that faces a consumer and a product-side edge that faces an interior volume of the body portion in which the product is held, the one or more tabs protruding above the consumer-side edge of the first flange or the second flange.

5. The resealable bag enclosure of claim 1, wherein the scalloped shape of the tab includes curved indentations on opposite lateral edges of the tab with a linear edge extending between and joining the lateral edges to each other.

6. The resealable bag enclosure of claim 5, wherein the curved indentations on the opposite lateral edges of the tab smoothly transition to the linear edge.

7. The resealable bag enclosure of claim 1, wherein the tab includes opposite lateral edges and a joining edge that extends between and joins the lateral edges with each other, wherein the scalloped shape of the tab is devoid of an angle between the joining edge and either the lateral edges that is ninety degrees or less.

8. The resealable bag enclosure of claim 1, wherein the tab includes opposite lateral edges and a joining edge that extends between and joins the lateral edges with each other, wherein the scalloped shape of the tab is devoid of an angle between the joining edge and either of the lateral edges that is less than one hundred thirty-five degrees.

9. The resealable bag enclosure of claim 1, wherein the tab is a first tab, and further comprising at least a second tab having the scalloped shape, the first tab, the at least the second tab, and a consumer-facing edge of the first zipper half or the second zipper half forming a curved waveform.

10. A method for forming a resealable bag enclosure, the method comprising:
forming a body portion configured to hold a product;
forming a zipper comprising a first zipper half and a second zipper half, the first zipper half including a first interlocking profile, the second zipper half including a second interlocking profile, the first interlocking profile and the second interlocking profile configured to repeatedly mate and separate from each other to repeatedly seal and open, respectively, the bag enclosure;
cutting the first zipper half to form a tab extending from the first zipper half or the second zipper half, the tab cut to have a scalloped shape; and
attaching the zipper to the body portion.

11. The method of claim 10, wherein the first zipper half is cut to form the scalloped shape of the tab to reduce a risk of snagging during sealing of the first zipper half and the second zipper half in an auto bag opening machine.

12. The method of claim 10, wherein the first zipper half is cut to form the scalloped shape of the tab to decrease a force required to open the zipper by ensuring only the first interlocking profile or only the second interlocking profile is opened at a time.

13. The method of claim 10, wherein the first zipper half is formed to include a first flange coupled with the body portion and from which the first interlocking profile projects, the second zipper half is formed to include a second flange coupled with the body portion and from which the second interlocking profile projects, each of the first flange and the second flange extending from a consumer-side edge that faces a consumer and a product-side edge that faces an interior volume of the body portion in which the product is held, the first zipper half cut to form the tab so the tab protrudes above the consumer-side edge of the first flange or the second flange.

14. The method of claim 10, wherein the first zipper half is cut to have the scalloped shape of the tab that includes curved indentations on opposite lateral edges of the tab with a linear edge extending between and joining the lateral edges to each other.

15. The method of claim 14, wherein the first zipper half is cut to form the curved indentations on the opposite lateral edges of the tab that smoothly transition to the linear edge.

16. The method of claim 10, wherein the first zipper half is cut to include, in the tab, opposite lateral edges and a joining edge that extends between and joins the lateral edges with each other, wherein the scalloped shape of the tab is cut to be devoid of an angle between the joining edge and either the lateral edges that is ninety degrees or less.

17. The method of claim 10, wherein the first zipper half is cut to include, in the tab, opposite lateral edges and a joining edge that extends between and joins the lateral edges with each other, wherein the scalloped shape of the tab is devoid of an angle between the joining edge and either of the lateral edges that is less than one hundred thirty-five degrees.

18. The method of claim 10, wherein the first zipper half is cut to form a first tab, and further comprising cutting the first zipper half to form at least a second tab having the scalloped shape, the first tab, the at least the second tab, and a consumer-facing edge of the first zipper half or the second zipper half forming a curved waveform.

19. A resealable bag enclosure comprising:
a body portion configured to hold a product;
a zipper attached to the body portion, the zipper comprising a first zipper half and a second zipper half, the first zipper half including a first interlocking profile, the second zipper half including a second interlocking profile, the first interlocking profile and the second interlocking profile configured to repeatedly mate and separate from each other to repeatedly seal and open, respectively, the bag enclosure; and
a tab protruding above an upper edge of the first zipper half or the second zipper half, the tab having a scalloped shape that reduces a risk of snagging during opening of the first zipper half and the second zipper half in an auto bag opening machine or decreases a force required to open the zipper, the scalloped shape of the tab including curved indentations on opposite lateral edges of the tab with a linear edge extending between and joining the lateral edges to each other, the curved indentations on the opposite lateral edges of the tab smoothly transitioning to the linear edge.

20. The resealable bag enclosure of claim 19, wherein the tab is a first tab, and further comprising at least a second tab having the scalloped shape, the first tab, the at least the second tab, and a consumer-facing edge of the first zipper half or the second zipper half forming a curved waveform.
